(19) United States
(12) Patent Application Publication
(10) Pub. No.: US 2009/0207316 A1
(43) Pub. Date: Aug. 20, 2009

(54) METHODS FOR SUMMARIZING AND AUDITING THE CONTENT OF DIGITAL VIDEO

(75) Inventors: Matthew D. Cupal, Park City, UT (US); Michael Flathers, Alpine, UT (US); Ajay Sreekanth, Berkeley, CA (US)

Correspondence Address: TRASKBRITT, P.C., P.O. BOX 2550, SALT LAKE CITY, UT, 84110, US

(73) Assignee: SORENSON MEDIA, INC., Salt Lake City, UT (US)

(21) Appl. No.: 12/033,663

(22) Filed: Feb. 19, 2008

(51) Int. Cl. H04N 5/14

(52) U.S. Cl. 348/700; 348/E05.062

(57) ABSTRACT

Methods of summarizing and auditing the content of digital video are disclosed. A method may include detecting scene changes within frames of a digital video by way of a scene change detection process. Thereafter, a thumbnail explosion may be provided of the scene changes within the digital video. In one embodiment, a system user may implement a scene change detection system in an audit mode, wherein the user may view a thumbnail explosion of scene changes and either accept or reject the media depending on whether inappropriate content is found. In another embodiment, a system user may implement a scene change detection system in a summary mode, wherein the user may view a thumbnail explosion in order to obtain a summary of the content of a digital video. In either embodiment, the system user may select a thumbnail from the thumbnail explosion to show an enlarged view of the thumbnail or may view the video beginning at the location of the selected thumbnail.

### FIELD OF THE INVENTION

The present invention, in various embodiments, relates generally to a method for analyzing digital media and, more specifically, to methods for summarizing and auditing the content of a digital video.

### BACKGROUND OF THE INVENTION

State of the Art: Digital media is more widely used today than ever before and with the increasing popularity of the internet and interactive websites, user-generated digital media has become increasingly popular.

Various websites, including news sites, dating sites, and media sharing sites may allow internet users to upload various forms of digital media to their websites in the form of photos, videos, and audio files. Companies that allow posting of user-generated media to their websites continue to face a difficult and lengthy task of auditing and filtering the uploaded media to ensure that the media does not contain any inappropriate content including pornography, obscenities, or other material that may be considered offensive in the context of the website and the website's audience. Conventionally, companies have monitored the material uploaded to their websites through a manual process in which an employee or a website auditor visually perceives the uploaded material and either accepts or rejects the material before publishing any of the material to the website. Alternatively, because the amount of material submitted to a website may be vast, in some cases upwards of 50,000 videos per day, some companies have solicited volunteers or website users to help police their websites and report any inappropriate material which users may have come across while navigating through the website.

Depending on the type of media and the desired level of auditing, filtering the vast content of media can prove to be challenging and time consuming. With certain forms of media, such as digital photos, a website auditor or website user simply needs to visually perceive the single image and make a subjective determination as to whether the image is appropriate for the website. In contrast to a photo with a single image or frame, an uploaded digital video may include approximately thirty frames per second of the video. Therefore, a company employee or website auditor is faced with a lengthy task of viewing the entire content of the video before being able to make a subjective determination as to whether the content of the video is appropriate for the website.

Furthermore, in some cases, simply watching the uploaded video at full speed may not be sufficient. For example, a video generated by an individual with malicious intent may include inappropriate material hidden within a single frame, and thus, it is possible for the single frame within the video to be offensive, hut when watched at full speed the offensive material may be undetectable. If, at some time, a website visitor observes the single offensive frame and then notifies other visitors of the website content, the reputation of the website may be damaged. Therefore, in order to ensure that no inappropriate material is contained within an uploaded digital video, a website auditor must view the uploaded digital video one frame at a time. Consequently, the process of auditing the content of user-generated digital videos may be time consuming, monetarily costly, and the throughput of individuals auditing the content may be vastly decreased.

There is a need for methods to increase the efficiency of accessing the content of digital media. Specifically, there is a need for increasing the efficiency of summarizing and auditing user-generated digital media.

### SUMMARY OF THE INVENTION

An embodiment of the present invention includes a method of auditing a digital video. The method comprises providing a scene change detector configured to detect scene changes within frames of the digital video and detecting at least one key frame within the digital video, wherein the at least one key frame exhibits a scene change from an adjacent frame of the plurality. The method further comprises providing a thumbnail explosion of the at least one key frame and auditing the at least one key frame, wherein auditing provides for the discovery or lack thereof of inappropriate material within the digital video.

Another embodiment of the present invention includes a method of summarizing a digital video. The method comprises providing a scene change detector configured to detect scene changes within frames of the digital video and detecting at least one key frame within the digital video, wherein the at least one key frame exhibits a scene change from an adjacent frame of the plurality. The method further comprises providing a thumbnail explosion of the at least one key frame and viewing the at least one key frame, wherein the digital video is summarized based on the content of the at least one key frame.

Yet another embodiment of the present invention includes a computer-readable media storage medium storing instructions that when executed by a processor cause the processor to perform instructions for operating and displaying the output of a scene change detection system. The instructions comprise adjusting an operational mode of the scene change detection system and detecting at least one key frame within a plurality of frames in a digital video, wherein the at least one key frame exhibits a scene change from an adjacent frame of the plurality. The instructions further comprise providing a thumbnail explosion comprising the at least one key frame.

### DESCRIPTION OF THE DRAWINGS

In the drawings:

FIG. 1 is a block diagram of a computer system including a processor-based device, in accordance with an embodiment of the present invention;

FIG. 2 is a block diagram of a digital video viewer for a collection of videos according to an embodiment of the present invention;

FIG. 3 is a block diagram of digital video viewer illustrating a thumbnail explosion according to an embodiment of the present invention;

FIGS. 4(a) and (b) are illustrations of an enlarged thumbnail image of a frame within a digital video, and a digital video within a video player according to an embodiment of the present invention;

FIG. 5 is a flow diagram of a method of auditing a digital video according to an embodiment of the present invention; and

FIG. 6 is a flow diagram of a method of summarizing a digital video according to an embodiment of the present invention.

### DETAILED DESCRIPTION OF THE INVENTION

The present invention, in various embodiments, comprises methods for auditing and summarizing the content of digital video to address efficiency concerns regarding the analysis of digital video.

In describing embodiments the present invention, the systems and elements incorporating embodiments of the invention are described to facilitate a better understanding of the function of the described embodiments of the invention as it may be implemented within these systems and elements.

In the following description, functions may be shown in block diagram form in order not to obscure the present invention in unnecessary detail. Conversely, implementations shown and described are exemplary only and should not be construed as the only way to implement the present invention unless specified otherwise herein. It will be readily apparent to one of ordinary skill in the art that the present invention may be practiced by numerous other partitioning solutions. For the most part, details concerning timing considerations and the like have been omitted where such details are not necessary to obtain a complete understanding of the present invention and are within the abilities of persons of ordinary skill in the relevant art.

Referring in general to the following description and accompanying drawings, various aspects of the present invention are illustrated to show its structure and method of operation. Common elements of the illustrated embodiments are designated with like numerals. It should be understood the figures presented are not meant to be illustrative of actual views of any particular portion of the actual structure or method, but are merely idealized representations which are employed to more clearly and fully depict the present invention.

When executed as firmware or software, the instructions for performing the methods and processes described herein may be stored on a computer readable medium. A computer readable medium includes, but is not limited to magnetic and optical storage devices such as disk drives, magnetic tape, CDs (compact disks), DVDs (digital versatile discs or digital video discs), and semiconductor devices such as RAM. DRAM, ROM, EPROM, and Flash memory.

In the context of digital video, it is common for a given frame within a video to be substantially similar to an adjacent preceding frame. Therefore, in order to locate significant scene changes within a digital video, a scene change detection process may be implemented. Scene change detection is a process of identifying scene changes within a video and is well known by a person having ordinary skill in the art. This process includes comparing two consecutive frames within a video and measuring the amount of change between the two frames. If the amount of change between the two consecutive frames is above a programmable threshold level, a scene change has occurred and the latter of the two frames may be labeled as a key frame. Otherwise, if the amount of change between the two consecutive frames is below the programmable threshold level, a significant scene change has not occurred. This process may be repeated for every frame within a video and, as a result, each significant scene change within a video may produce a key frame. Scene change detection may also be known as, but not limited to, scene detection, key frame detection, and key frame extraction.

In various embodiments of the present invention, significant scene changes within a video may be detected by measuring and comparing the luminescence and/or chrominance of like pixels in adjacent frames within a video. If a luminescence and/or chrominance difference value between like pixels of adjacent frames is greater than a programmable threshold value, the latter frame may be labeled as a key frame signifying a scene change. Other known methods of detecting scene changes may be within the scope of the invention including, but not limited to, comparisons based on pixels, edges, fractals, or any method which uses thresholds to compare frames, a variety of statistically-based calculations of motion vectors, comparisons of discrete cosine transforms, wavelets, techniques involving quantization of gray-level histograms, techniques involving in-place template matching, semblance metric (SEM) measurements, neural network approaches, or other methods known in the art.

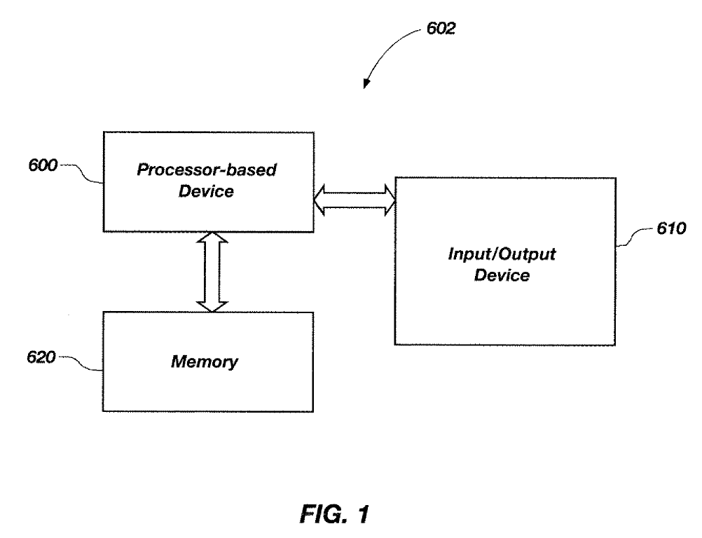

FIG. 1 illustrates a computer system 602 including a processor-based device 600, memory 620, and an input/output (I/O) device 620 in accordance with an embodiment of the invention. Processor-based device 600, such as a computer comprising of a central processing unit (CPU), may be operably coupled to and may communicate with I/O device 610 which is configured to display the output of a scene change detection system stored within memory 620. As described below, the output of a scene change detection process may be displayed via I/O device 610. For example only, I/O device 610 may comprise a computer monitor and memory 620 may comprise of random access memory (RAM).

According to various embodiments of the invention, a scene change detection process may be implemented by a system user in an audit mode or, alternatively, in a summary mode. While operating in an audit mode, a system user may run a scene change detection process on a digital video and view, via I/O device 610, a thumbnail explosion of significant key frames of the digital video in order to audit the content of the video. While operating the scene detection process in a summary mode, a system user may run a scene change detection process on a digital video and view, via I/O device 610, a thumbnail explosion of key frames of the digital video in order to obtain a summary of the content of the video. As such, a system user may select the operational mode of the scene change detection system, while operating in an audit mode, a scene change detection system may exhibit a level of sensitivity that is greater than the level of sensitivity while operating in a summary mode. Therefore, while tuned to operate in an audit mode, a scene change detection system will recognize less significant changes in like pixels within adjacent frames of the video, and as a result, a greater number of key frames will be generated in a thumbnail explosion displayed by I/O device 610.

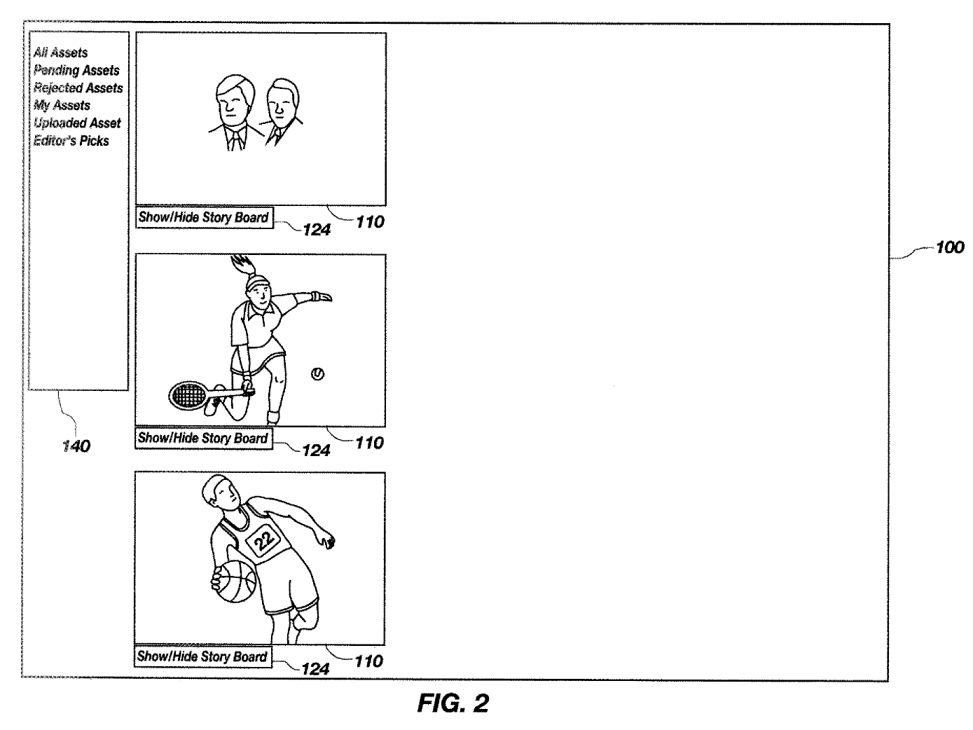

FIG. 2 illustrates a block diagram of a video viewer 100 as part of a scene change detection system, wherein video viewer 100 is configured to display an output of the change scene detection system via I/O device 610 (see FIG. 1). Video viewer 100 may include a list of folders 140 available to a system user and configured for storing media or assets uploaded to the computer or the network of the system user. The list of folders 140 may include folders titled, such as, but not limited to, “All Assets,” “Pending Assets,” “Rejected Assets,” “My Assets,” “Uploaded Assets,” and “Editor's Picks.” Video viewer 100 may also include a show/hide storyboard icon 124 that may be selected to show or hide, as described in greater detail below, a thumbnail explosion 130 of the video displayed in representative frame 110.

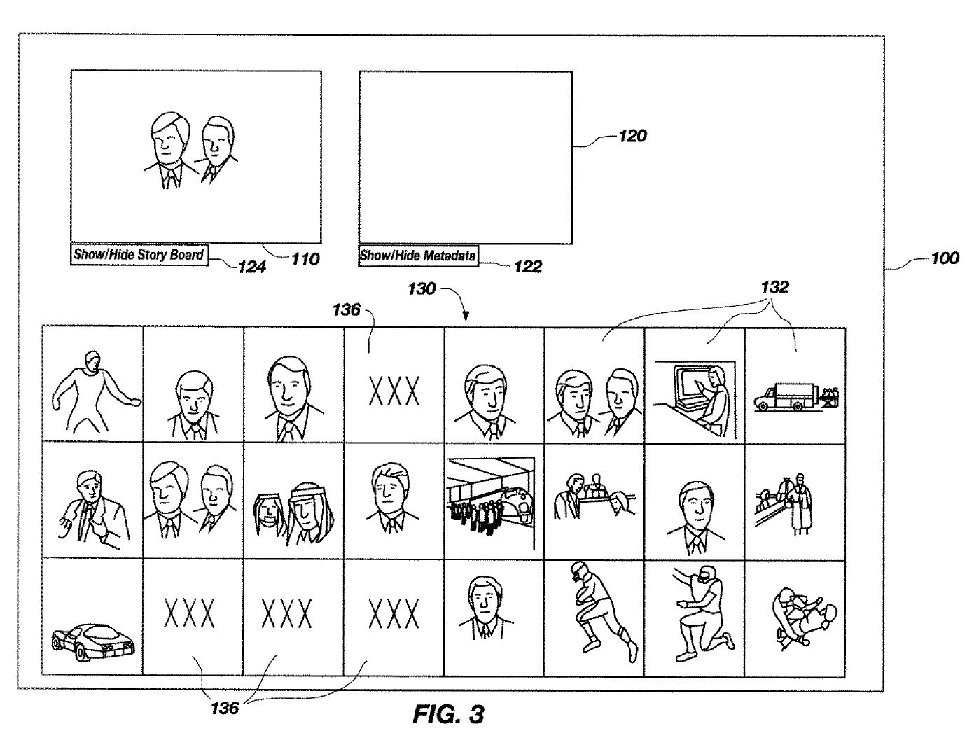

FIG. 3 illustrates a block diagram of a video viewer 100 comprising a thumbnail explosion 130 of an uploaded video according to an embodiment of the invention. As described above in reference to FIG. 2, video viewer 1 may include a representative frame 110 of an uploaded video. Video viewer 100 may include a list of image stills or representative frames 10 of uploaded digital videos that may be stored on a computer or a network of a system user. Video viewer 100 may also include metadata 120 correlating to each representative frame 110 in the representative list and may be comprised of information relating to a corresponding video such as, but not limited to, the title of the video, the number of times the video has been viewed, approval status of the video, the author of the video, the name of the person who submitted the video, the date of video submittal, and a description of the video. A system user may hide or show metadata 120 within video viewer 100 by selecting or clicking on the show/hide metadata icon 122. In addition, video viewer 100 may include a show/hide storyboard icon 124 that may be selected to show or hide a thumbnail explosion 130 of representative frame 110. Selecting the show/hide storyboard icon 124 may generate the thumbnail explosion 130 comprising thumbnails 132 of significant key frames generated by a scene change detection system, wherein the key frames represent significant scene changes within the corresponding video. As described above, thumbnail explosion 130 may comprise a grid of thumbnails 132 provided to allow a user to audit the content of the video displayed in representative frame 110, or to provide a user with a summary of the content of the video displayed in representative frame 110. As illustrated in FIG. 3, thumbnail explosion 130 includes thumbnails 136 comprising potentially inappropriate material (denoted by ‘XXX’).

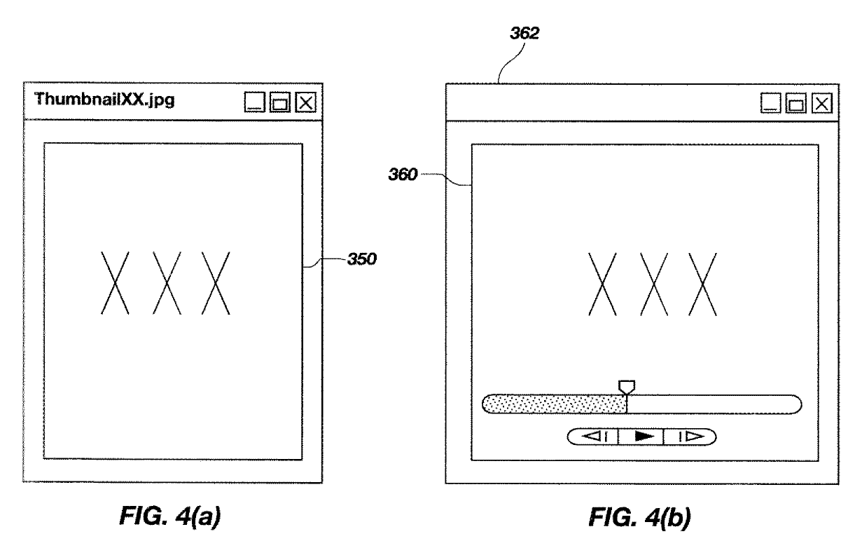

In one embodiment of the invention, a user may select, or click on, a thumbnail 132/136 to generate a blown-up or enlarged version 350, as shown in FIG. 4(a), of the selected thumbnail. For example, if a user suspects that a thumbnail 136 within thumbnail explosion 130 contains inappropriate material, or if the user simply wishes to view an enlarged version of any thumbnail 132/136, the user may click on and enlarge the individual thumbnail for further inquiry. Additionally, if a user wishes to view the video at full speed, a user may click on an individual thumbnail 132/136 and a video player 362 configured to play a video may be loaded. Thereafter, the corresponding video 360, as shown in FIG. 4(b), will play at full speed beginning at the location represented in the selected thumbnail 132/136.

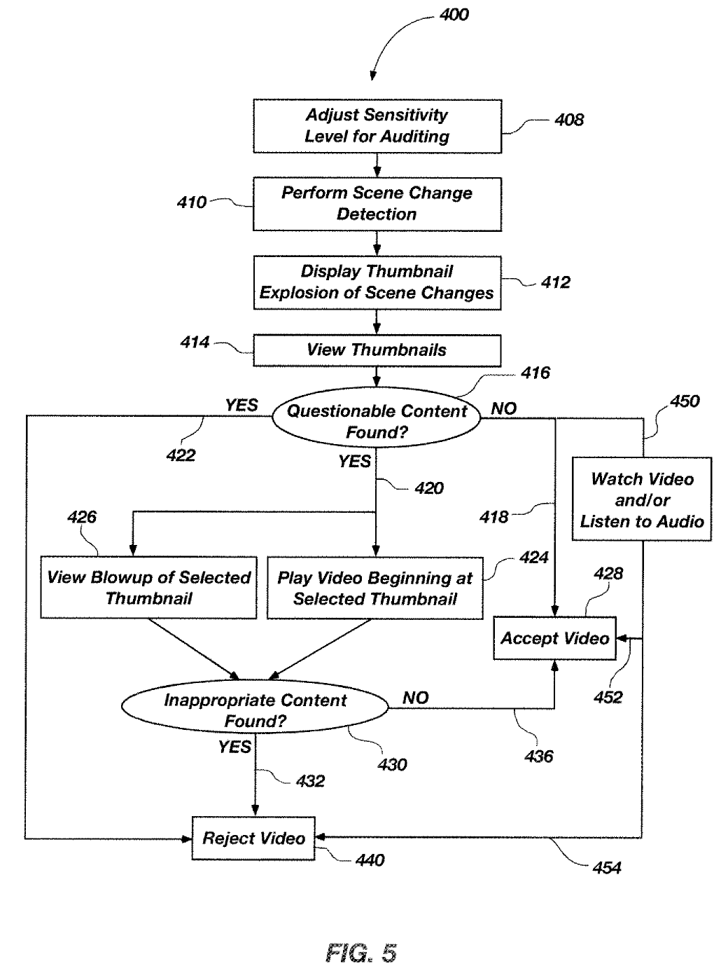

FIG. 5 is a flow diagram illustrating a method 400 for auditing the content of a digital video. Initially, a scene change detection system may be adjusted by a system user to operate in a mode configured for auditing the content of a digital video 408. Thereafter, a scene change detection process is performed 410 and a thumbnail explosion based on the detected scene changes is displayed 412. As described above, the sensitivity threshold of a scene detection system in an audit mode may be configured to detect even minor differences in like pixels within adjacent frames.

Subsequent to displaying a thumbnail explosion 412, a system user may view the thumbnails 414 and make an initial subjective determination whether any questionable content is present in the thumbnails 416. If, upon viewing the displayed thumbnail images, a determination is made that no questionable content exists 418, the digital video may be accepted by the system user 428 without further investigation, or alternatively, a system user may watch the video and/or listen to the audio 450, and thereafter accept 452 or reject 454 the video. Otherwise, if a determination is made that questionable content is found 420, 422 within the displayed thumbnails, a system user may reject the digital video 340 without further investigation, or alternatively, may inquire further by viewing an enlarged or blown-up view of a selected thumbnail 426. Additionally, a system user may play the digital video at full speed beginning at the location represented in the selected thumbnail 424. After a user has viewed a blown-up thumbnail or viewed the digital video at full speed, a determination may then be made as to whether inappropriate content is found within the digital video. If a determination is made that no inappropriate content exists 436, the user may accept the digital video 428. If a determination is made that the video does contain inappropriate content, a user may reject the video 440.

As opposed to conventional means of auditing digital videos, various embodiments of the invention provide for an efficient method of auditing the content of digital videos. For example, viewing a thumbnail explosion of detected scene changes benefits a video or website auditor by allowing the auditor to quickly ascertain, without single stepping through each frame, whether a video contains offensive or inappropriate material. Additionally, it may be more efficient and reliable for an auditor to audit a video by viewing key frames rather than watching the video at full speed due to the fact that a single frame may not be visible to a system user when viewed at full speed. Furthermore, any frame maliciously inserted within a digital video may be detected by a scene change detection system, displayed in a thumbnail explosion, and quickly discovered by a website or video auditor.

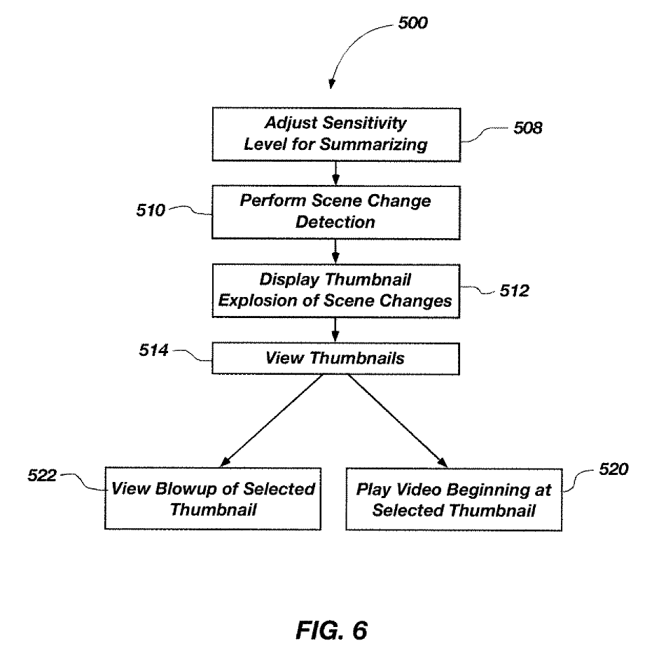

Detected scene changes displayed in a thumbnail explosion may depend on whether a system user is operating in an audit mode or a summarization mode. In an audit mode, the change scene detection system may be adjusted to a high sensitivity and, therefore, minor scene changes may be detected. Conversely, in a summarization mode, the sensitivity threshold of a scene detection system may be decreased and, therefore, only major differences in like pixels within adjacent frames are detected. As a result, in a summarization mode, a system user may be provided with a thumbnail explosion wherein the thumbnails may be based on a summary of the video rather than a thumbnail explosion comprising even minor changes in order to detect offensive material, as in the audit mode. FIG. 6 is a flow diagram illustrating a method of obtaining a summary of a digital video 500. Initially, as described above, a scene change detection system may be adjusted by a system user to a level of sensitivity configured for summarizing the content of a digital video 508. Thereafter, a scene change detection process may be performed 510 and a thumbnail explosion based on the detected scene changes may be displayed 512. Subsequent to displaying a thumbnail explosion 512, a system user may view the thumbnails 514. For further inquiry into the displayed thumbnails, a system user may view a blown-up or enlarged version of a selected thumbnail 520, or alternatively, a user may play the video at full speed beginning at the location represented in the selected thumbnail 520.

Specific embodiments have been shown by way of example in the drawings and have been described in detail herein; however, the invention may be susceptible to various modifications and alternative forms. It should be understood that the invention is not intended to be limited to the particular forms disclosed. Rather, the invention includes all modifications, equivalents, and alternatives falling within the spirit and scope of the invention as defined by the following appended claims.

1. A method of auditing a digital video, comprising:
providing a scene change detector configured to detect scene changes within a plurality of frames in the digital video;
detecting at least one key frame within the plurality of frames, wherein the at least one key frame exhibits a scene change from an adjacent frame of the plurality; and
auditing the at least one key frame, wherein auditing provides for the discovery or lack thereof of inappropriate material within the digital video.

2. The method of claim 1, further comprising providing a thumbnail explosion comprising the at least one key frame after detecting the at least one key frame.

3. The method of claim 1, further comprising adjusting the scene change detector to an audit mode prior to detecting the at least one key frame.

4. The method of claim 2, further comprising selecting one key frame of the at least one after providing the thumbnail explosion.

5. The method of claim 4, wherein selecting one key frame generates an enlarged version of the selected key frame.

6. The method of claim 4, wherein selecting one key frame causes the digital video to play within a media player beginning at a location represented by the selected key frame.

7. The method of claim 2, wherein providing a thumbnail explosion comprises providing a thumbnail explosion in a video viewer.

8. The method of claim 1, further comprising providing metadata corresponding to the video prior to detecting at least one key frame.

9. A method of summarizing a digital video, comprising:
providing a scene change detector configured to detect scene changes within a plurality of frames in the digital video;
detecting at least one key frame within the plurality of frames, wherein the at least one key frame exhibits a scene change from an adjacent frame of the plurality; and
viewing the at least one key frame, wherein the digital video may summarized based on the content of the at least one key frame.

10. The method of claim 9, further comprising providing thumbnail explosion comprising the at least one key frame after detecting the at least one key frame.

11. The method of claim 9, further comprising adjusting the scene change detector to a summary mode prior to detecting the at least one key frame.

12. The method of claim 10, further comprising selecting one key frame of the at least one after providing the thumbnail explosion.

13. The method of claim 12, wherein selecting one key frame generates an enlarged version of the selected key frame.

14. The method of claim 12, wherein selecting one key frame causes the digital video to play within a media player beginning at a location represented by the selected key frame.

15. The method of claim 10, wherein providing a thumbnail explosion comprises providing a thumbnail explosion in a video viewer.

16. The method of claim 9, further comprising providing metadata corresponding to the digital video prior to detecting at least one key frame.

17. A computer-readable media storage medium storing instructions that when executed by a processor cause the processor to perform instructions for operating and displaying the output of a scene change detection system, the instructions comprising:
adjusting an operation mode of the scene change detection system; and
detecting at least one key frame within a plurality of frames in a digital video, wherein the at least one key frame exhibits a scene change from an adjacent frame of the plurality.

18. The computer-readable media storage medium of claim 17, further comprising providing a thumbnail explosion comprising the at least one key frame after detecting the at least one key frame.

19. The computer-readable media storage medium of claim 17, wherein adjusting a sensitivity level comprises adjusting a sensitivity level to an audit mode.

20. The computer-readable media storage medium of claim 17, wherein adjusting a sensitivity level comprises adjusting a sensitivity level to a summary mode.

21. The computer-readable media storage medium of claim 18, wherein providing a thumbnail explosion comprises providing a thumbnail explosion in a video viewer.

22. The computer-readable media storage medium of claim 17, further comprising providing metadata corresponding to the digital video prior to detecting at least one key frame.

23. The computer-readable media storage medium of claim 18, further comprising providing an enlarged version of a selected key frame of the at least one after providing the thumbnail explosion.

24. The computer-readable media storage medium of claim 18, further comprising playing the digital video within a media player beginning at a location represented by a selected frame of the at least one after providing the thumbnail explosion.
